(19) United States
(12) Patent Application Publication
(10) Pub. No.: US 2023/0132493 A1
(43) Pub. Date: May 4, 2023

(54) IMPORTING WORKLOAD DATA INTO A SHARDED VIRTUAL DISK

(71) Applicant: Nutanix, Inc., San Jose, CA (US)

(72) Inventors: Tabrez Parvez MEMON, Campbell, CA (US); Harshit AGARWAL, Newark, CA (US); Amod Vilas JALTADE, San Jose, CA (US)

(21) Appl. No.: 17/452,772

(22) Filed: Oct. 28, 2021

(51) Int. Cl. G06F 3/06

(52) U.S. Cl. CPC G06F 3/0635; G06F 3/0664; G06F 3/0659; G06F 3/0604; G06F 3/0611; G06F 3/0683

(57) ABSTRACT

Methods, systems, and computer program products for importing a workload from an external system into a virtualization system. A virtual disk (vDisk) is created based on analysis of the data layout of the workload. The vDisk is sharded into a plurality of non-overlapping shards. Independently executing shard controllers are assigned to the non-overlapping shards. On an ongoing basis, the plurality of shard controllers manage respective shards of the plurality of shards. I/O activity on at least some individual ones of the plurality of shard controllers is monitored on an ongoing basis. Two or more shard controllers can be merged into a single shard controller when the I/O activity on the two or more shard controllers is measured to be below a threshold. A single shard controller can be split into two or more shard controllers when I/O activity on the single shard controller is measured to be above a threshold.

### TECHNICAL FIELD

This disclosure relates to virtualized computer systems, and more particularly to techniques for mapping workload data from an external system onto a high-performance sharded virtual disk.

### BACKGROUND

Disk apportioning (e.g., sharding) is a technique that has been long used in an attempt to exploit parallelism that could be had if the data on a single data storage drive is physically distributed across multiple data storage drive portions (e.g., shards) that are in turn distributed to respective data storage hardware. When the portions (e.g., shards) are defined to be non-overlapping, then as many I/Os (input/outputs or IOs) as there are portions can be concurrently processed by the multiple respective data storage hardware.

While such techniques can potentially offer significant performance improvements—at least when I/Os to the various portions are balanced with respect to each other—the foregoing technique relies on the ability of an operating system and/or an application to be configured in such a manner as to explicitly reconfigure a single storage area into multiple storage areas (e.g., shards) corresponding to multiple respective data storage hardware. Performing reconfiguration of an operating system and/or application is often not convenient, or not even possible. For example, if a particular operating system is deployed as binary files rather than in source code, and/or if a particular application is only licensed for use in its unmodified form, etc., then reconfiguration of an operating system and/or application might not be possible.

This situation is made more complicated by the advent of virtualization systems. In virtualization systems, an application (e.g., executable modules as well as non-volatile data) can move (e.g., be migrated) from one node to another node completely under control of a hypervisor and/or its agents. In certain application domains, such as is exemplified by a database server application (e.g., SQL), while it might be reasonable to migrate executable modules of an application from one node to another node, it might be extremely expensive to move even portions the data of the database to another location. Consider that a modern data volume (e.g., hosting database files) can be extremely large, sometimes consuming tens or hundreds of terabytes. As such, moving from one location to another (e.g., migrating) even a few percent of the tens or hundreds of terabytes presents an extremely heavy load on the computing infrastructure.

As such, use of legacy techniques as heretofore described often leads to non-optimal configurations. In some cases it is expensive and/or inconvenient and, for at least some of the previously-mentioned reasons, it is sometimes not possible to apportion the data of a modern data volume onto independent disk hardware. Nevertheless, users demand high performance from their operating system and their applications. What is needed is a way to deliver the demanded high performance, yet without having to modify the operating system or application code to comport with a sharded apportionment.

### BRIEF DESCRIPTION OF THE DRAWINGS

The drawings described below are for illustration purposes only. The drawings are not intended to limit the scope of the present disclosure.

FIG. 1A depicts an external system hosting a workload that is to be imported into a virtualization system, according to an embodiment.

FIG. 1B depicts a virtualization system into which a workload of an external system is to be imported, according to an embodiment.

FIG. 1C exemplifies a first virtualization system configuration in a condition that is ready for application of techniques to implement creation and maintenance of sharded virtual storage areas.

FIG. 1D exemplifies a second virtualization system configuration showing a graphic representation of sharded virtual storage areas in a virtualization system, according to an embodiment.

FIG. 1E depicts a thread-to-node association technique, according to an embodiment.

FIG. 1F depicts an I/O routing technique, according to an embodiment.

FIG. 2A is a flowchart showing a method for dynamic creation and maintenance of sharded virtual storage areas, according to an embodiment.

FIG. 2B is a flowchart showing a method to choose between changing a virtual disk data layout or changing a shard controller deployment, according to an embodiment.

FIG. 3 is a diagram showing a primary controller deployment in a system that implements dynamic creation and maintenance of shard controllers in a virtualization system, according to an embodiment.

FIG. 4A is a state chart showing a dynamic shard controller redeployment technique that implements initial creation and ongoing maintenance of sharded virtual storage areas of a virtualization system, according to an embodiment.

FIG. 4B1 is a diagram showing dynamic shard controller redeployment techniques that implement shard controller merging and splitting, according to an embodiment.

FIG. 4B2 is a diagram showing a dynamic shard controller redeployment technique that implements shard controller merging of multiple non-contiguous shards, according to an embodiment.

FIG. 5A, FIG. 5B, FIG. 5C, and FIG. 5D depict virtualization system architectures comprising collections of interconnected components suitable for implementing embodiments of the present disclosure and/or for use in the herein-described environments.

### DETAILED DESCRIPTION

Aspects of the present disclosure solve problems associated with using computer systems for optimizing I/O (input/output or IO) performance to and from virtual storage areas of a virtualization system. Some embodiments are directed to approaches for assigning unique I/O handling threads to non-overlapping shards of a virtual disk. The accompanying figures and discussions herein present example environments, systems, methods, and computer program products for dynamic creation and maintenance of shard controllers in a virtualization system.

### Overview

Computing hardware (e.g., CPUs and storage devices) have changed dramatically over the recent decades. Historically (e.g., circa 1990) persistent storage devices (e.g., hard disks) have been orders of magnitude slower than CPUs. As such, workloads that have even a modest amount of disk I/O become I/O bound. That is, historically, such workloads would be more often waiting for disk I/O completions than it would be waiting for CPU cycles.

Even as new persistent storage technologies have emerged (e.g., solid state drives) there are many types of workload that are still I/O bound. While it would be advantageous to be able to take advantage of independent storage hardware, there are many pitfalls to doing so. In some cases, large databases (e.g., involving multiple terabytes) are mapped into a contiguous address space that corresponds to a large storage device. When such a database is operated on by a database server module, it can happen that many hundreds of users are “hitting” the database at the same time. This sets up the scenario where, in aggregate, the multi-workload is I/O bound—in spite of deployment of faster storage technologies. Even when some sort of redundancy across independent drives (e.g., RAID) is implemented, there are hardware considerations that limit exploitation of parallelism. For example, RAID hardware might be limited to handling only a fixed number (e.g., 4) of independent drives. A better way would be to virtualize the storage in a manner that can be tuned based on actual real-time monitoring of the workload.

Disclosed herein are techniques for dynamic creation and maintenance of sharded virtual storage areas of a virtualization system. Moreover, disclosed herein are techniques for importing a workload from an external system (e.g., a database system) to a virtualization system that automatically creates and dynamically maintains instances of shard controllers so as to maintain high performance of a workload even as workload conditions change.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material, or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

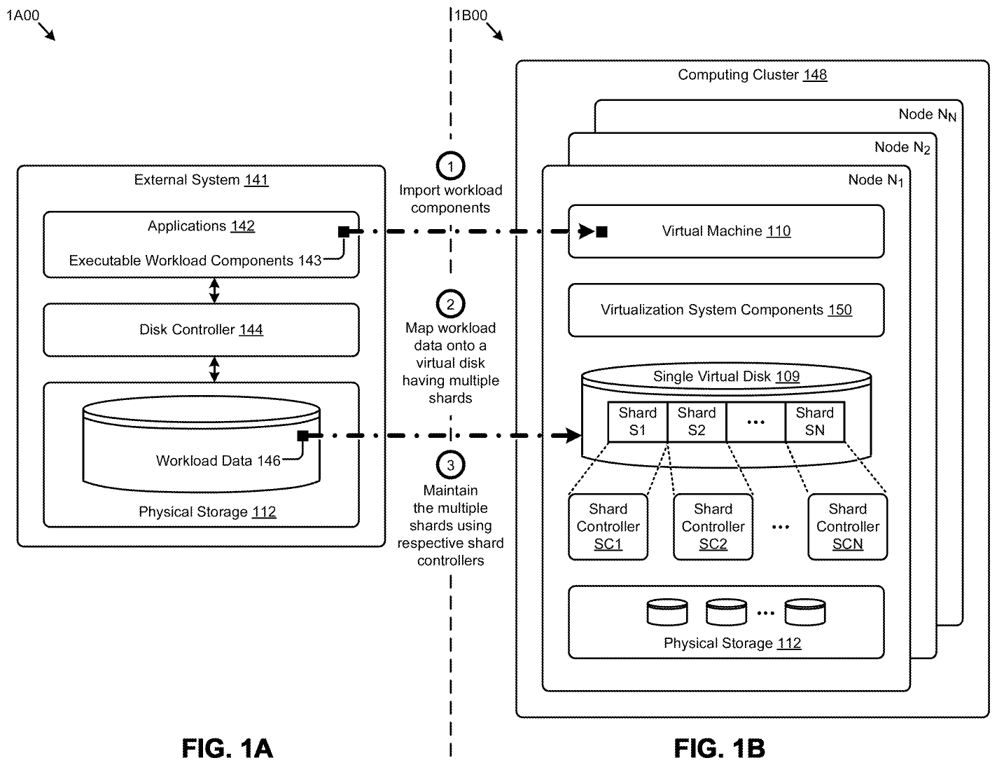

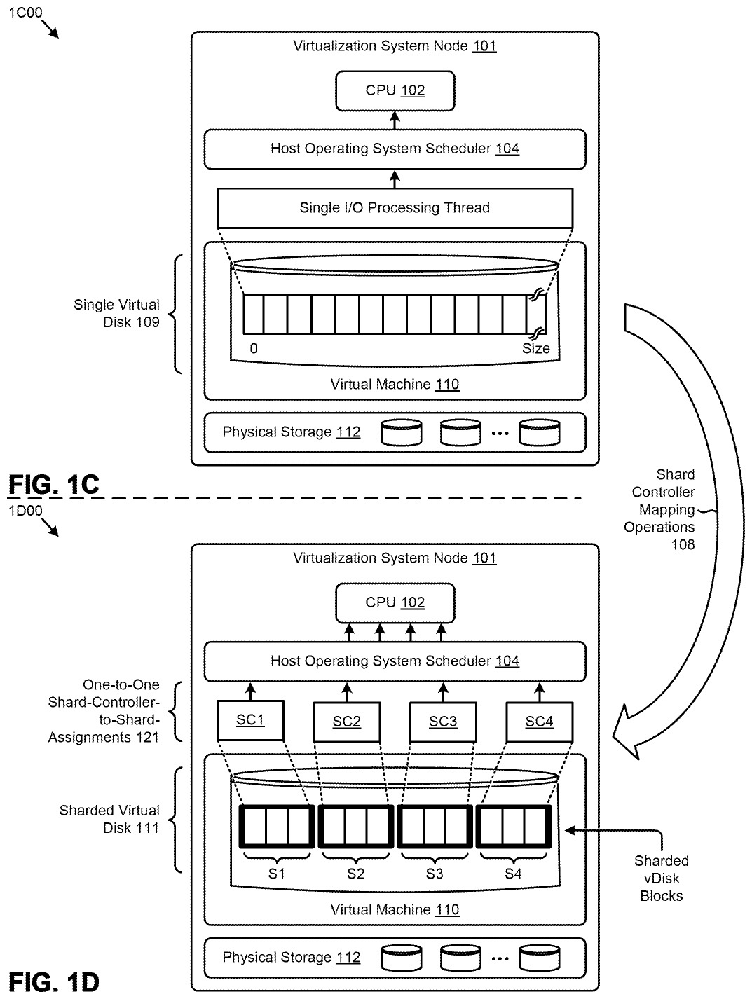

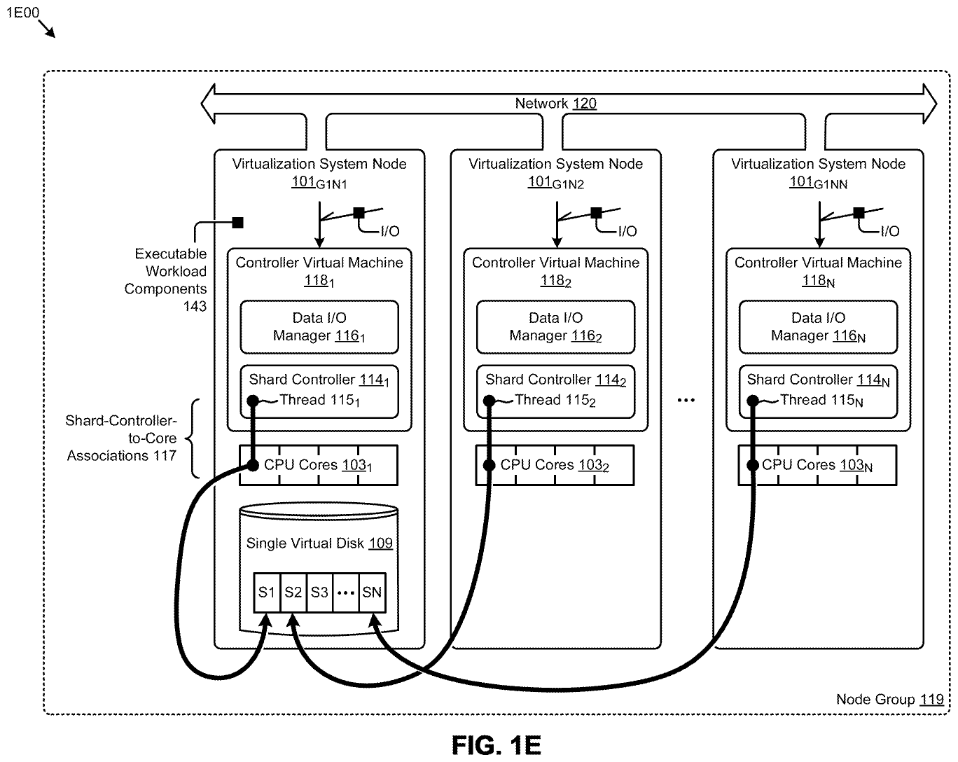

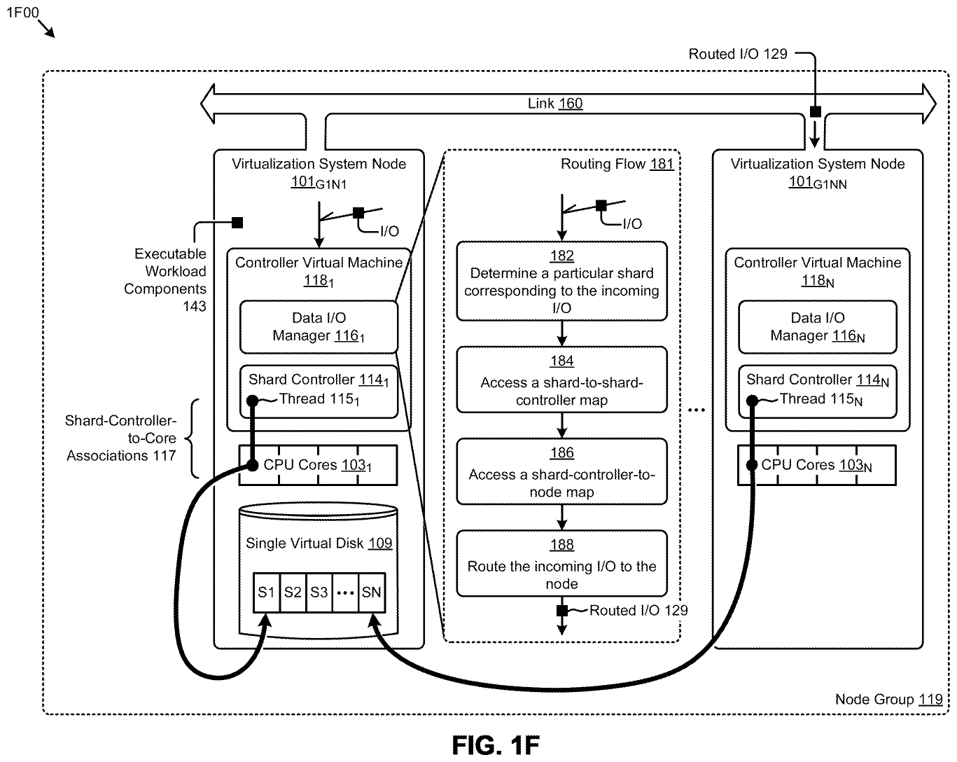

FIG. 1A depicts an external system hosting a workload that is to be imported into a virtualization system. As an option, one or more variations of the external system 1A00 or any aspect thereof may be implemented in the context of the architecture and functionality of the embodiments described herein and/or in any environment.

Computing applications, as well as their corresponding software/hardware architectures, often have a much longer lifespan than the computing equipment onto which the application is deployed. In some cases, an architecture that was tuned based on then-current hardware (e.g., exhibiting fast CPU speeds, slow disk drives, and very slow networking) might become outdated due to technology improvements. This often results in the deployed application becoming more and more non-optimal. At the same time, it is not always possible to cause the application vendor and/or turnkey system vendor to re-optimize. In some cases, the application vendor and/or turnkey system vendor may have gone out of business, leaving the deployer to deal with the re-optimization problem by itself.

One approach to address this problem is to make modifications to the operating system that supports the application, however this is only sometimes possible, and almost never is such an approach a practical approach. Another approach is to garner flexibility by redeploying the application, or even just some selected workload or portions of workloads of the application, into an environment that is flexible.

As used herein a workload is a computing task that is processed on computing equipment. A workload may comprise an executable portion and a data portion. Strictly as an example, an executable portion of a workload might read and write workload data from/to a pre-defined extent of a non-volatile storage device (e.g., hard drive). Such reading and writing, by an executable portion of a workload, to a pre-defined extent of a non-volatile storage device presents the sort of architecture that is at least potentially the sort of architecture that is susceptible to becoming non-optimal as time passes. Such a workload could be redeployed and re-optimized by moving the workload to a modern virtualized computing cluster.

The combination of FIG. 1A and FIG. 1B depicts one possible mechanism for importing a workload from a legacy external system into a modern virtualized computing cluster. As shown, FIG. 1A exemplifies a legacy external system 141 that executes one or more applications 142, which applications, either individually or in combination, service a workload. The shown external system includes physical storage 112 in which a persistent storage device holds workload data 146. A disk controller 144 provides an interface between any one or more computing entities (e.g., the shown executable workload components 143) and the physical storage. The shown external system suffers from the heretofore mentioned deficiencies, namely that the workload can become severely I/O bound as the performance of the workload becomes more and more dependent on writing/reading workload data to/from the physical storage.

As previously mentioned, one approach is to import the workload (e.g., a database client-server workload) into a virtualization system that automatically reconfigures itself to maintain high performance of a workload even as workload conditions change, and even as changes in the underlying computing technologies are brought to bear. Once workload components have been selected (operation 1), workload data comprising non-volatile data (e.g., data of a portion of a hard drive) can be mapped onto a virtual disk (operation 2), and that virtual disk can be managed for high performance on an ongoing basis even as workload conditions change, and even as changes in the underlying computing technologies are brought to bear. More specifically, the virtual disk can be apportioned into shards, and those shards can be associated with respective shard controllers (operation 3).

One implementation of a modern virtualization system is shown and described in FIG. 1B.

FIG. 1B depicts a virtualization system into which a workload of an external system is to be imported. As an option, one or more variations of virtualization system 1B00 or any aspect thereof may be implemented in the context of the architecture and functionality of the embodiments described herein and/or in any environment.

As shown, computing cluster 148 is composed of N number of nodes (e.g., node N₁, node N₂, . . . node N_{N}). Each node in turn can support a virtual machine 110 that interfaces with any of a variety of virtualization system components 150 (e.g., a hypervisor, a virtual disk subsystem, etc.). Each node supports a CPU 102, as well as any number of node-local instances of physical storage 112, and each node can support any number of virtual disks (e.g., the shown single virtual disk 109).

With respect to the foregoing operation 3, a virtual disk (e.g., the shown single virtual disk 109) can be sharded and each shard can be associated with a corresponding shard controller. As used herein, a shard controller is executable code that processes I/Os for a corresponding shard of a virtual disk. A shard controller can be implemented as a thread that has an affinity to a particular CPU core. In this manner the parallelism afforded by multiple CPU cores can be exploited by assigning individual ones of the multiple CPU cores to handle only I/O operations pertaining to their respective shard. In the specific configuration shown, shard controller SC1 handles only I/O operations pertaining to shard S1, shard controller SC2 handles only I/O operations pertaining to shard S2, and shard controller SCN handles only I/O operations pertaining to shard SN.

Any known techniques can be applied when defining shards and when associating affinities between shard controller threads and CPU cores. One selection of such techniques for creating shards and maintaining sharded controllers depicted by the shard controller mapping operations of FIG. 1C and FIG. 1D.

FIG. 1C exemplifies a first virtualization system configuration in a condition that is ready for application of techniques to implement creation and maintenance of sharded virtual storage areas. As an option, one or more variations of first virtualization system configuration 1C00 or any aspect thereof may be implemented in the context of the architecture and functionality of the embodiments described herein and/or in any environment.

FIG. 1C, and more specifically shard controller mapping operations 108, can be best understood by considering FIG. 1C and FIG. 1D in combination. Specifically, while both FIG. 1C and FIG. 1D depict a virtualization system node 101, and while both FIG. 1C and FIG. 1D depict respective instances of CPU 102, respective instances host operating system scheduler 104, respective instances of virtual machine 110, and their respective instances of physical storage, the two configurations differ at least because the single virtual disk 109 of FIG. 1C is represented as sharded virtual disk 111 in FIG. 1D. Furthermore, the two configurations differ at least because second virtualization system configuration 1D00 of FIG. 1D depicts one-to-one shard-controller-to-shard assignments 121, where shard controller SC1 handles only I/O operations pertaining to shard S1, shard controller SC2 handles only I/O operations pertaining to shard S2, shard controller SC3 handles only I/O operations pertaining to shard S3, and shard controller SC4 handles only I/O operations pertaining to shard S4. This is different from the architecture of FIG. 1C where the entirety of a particular vDisk gets handled by a corresponding single I/O processing thread.

Workloads that rely on a single I/O processing thread per vDisk often become bottlenecked due to CPU cycle availability and caching limitations. On top of that, due to various threading models, it often happens that when each vDisk gets handled by a corresponding single thread for execution of all the tasks (e.g., I/Os) related to it, that limits access to the full range of computing resources configured into and/or offered by a computing node.

One legacy approach to address this unwanted limitation has been to use multiple vDisks hosted across different nodes, however this requires either (1) some support from an application (e.g., for the application to apportion its own data) or (2) the use of external tools such as logical volume management (LVM), or (3) control of the functionality of the operating system(s) that run on the node. Such legacy approaches—if even possible—incur not only unwanted management overhead but also often requires intervention from system administrators. To address such deficiencies in the legacy approaches, an improved approach involves splitting a single vDisk entity into multiple sub-vDisks (known as shards) such that each shard is a non-overlapping logical range of data on the vDisk. Further, each shard is assigned one-to-one to a respective thread that is then used to handle I/Os to/from that shard.

In some embodiments, initial creation of a sharded configuration can be done in such a way that the number of shards is independent of the vDisk size. For example, a number of shards might be determined based on a size parameter of the underlying computing equipment. The number and configuration of shards can be changed at any point during the lifetime of the vDisk. For example, a particularly “busy” shard can be split into multiple shards. Alternatively, two or more related (e.g., abutting) shards can be merged into a single shard. As such, the activity across a group of shards can be balanced.

As discussed herein, the computing entity responsible for handling vDisk I/O for a particular shard is called a shard controller. A particular shard controller is specific to a single thread, and hence it is able to perform all the I/Os for that shard without taking any locks with respect to other threads. In embodiments, as many threads as there are shards are assigned to handling vDisk I/O operations. This results in single thread guarantees.

In some scenarios, the full address space of a virtual disk can be covered by apportioning the address space of the virtual disk into relatively small (e.g., 1 MB) shards (e.g., comprising individual vDisk blocks). In certain such scenarios, in particular, when the virtual disk is relatively large (e.g., 1 GB or larger) this gives rise to the situation where many independent shard controllers are needed to cover the full address space of a virtual disk. In such a situation, many of the foregoing independent shard controllers can be mapped to a single CPU core.

As such, it can also happen that multiple vDisk blocks are logically assigned to a particular shard, which shard is then mapped to a corresponding thread. A vDisk block-to-shard-assignment may be done using any known technique. Moreover any one or more vDisk blocks that are assigned to a particular shard may or may not be contiguous with respect to any other vDisk blocks that are assigned to the same particular shard.

As is understood by those of skill in the art, apportioning a virtual disk into relatively small (e.g., 1 MB) shards reduces the likelihood that any particular individual shard will present an I/O hotspot during virtual disk I/O. Thresholds pertaining to over utilization (e.g., redline thresholds, hotspots, etc.) as well as thresholds pertaining to underutilization can be defined based at least in part on the size of an underlying shard.

When sharding on the same node (e.g., over a particular vDisk), a shard and/or its shard controller can be viewed as being compute resources. The higher the number of shards, the higher the amount of compute resources allocated to a vDisk. Depending on the workload being run on a vDisk, different vDisks may be optimized by dynamically changing the vDisk's sharding configurations at different times during the lifetime of the sharded entity (e.g., vDisk). The sharding layout and corresponding one-to-one assignments to threads can change at any time, depending upon how a vDisk is being used by the application running on it.

In one embodiment, each shard is responsible for a unique, non-overlapping set of 1 MB logical ranges (e.g., ranges of virtual blocks). The distribution of these ranges to a shard depends on a number of factors, for example the number of shards in a shard layout configuration for a vDisk. The particular assignment of shard controllers to a particular vDisk can span across multiple nodes, thereby offering a nearly unlimited amount of processing to a nearly unlimited number of shards of a single vDisk. In some cases, CPU cores, and more specifically, particular shard threads, are given a specific affinity to respective particular CPU cores. In some cases, the assignment of a particular next shard controller to a particular next CPU core is performed using a round-robin algorithm across a set of nodes of a computing cluster. An example application of such a round-robin algorithm to assign shard controllers across nodes of a computing cluster is shown and described as pertains to FIG. 1E.

FIG. 1E depicts a thread-to-node association technique. As an option, one or more variations of thread-to-node association technique 1E00 or any aspect thereof may be implemented in the context of the architecture and functionality of the embodiments described herein and/or in any environment.

A node group 119 is selected from nodes of a computing cluster. A node group can be selected using any known technique and can include any number of virtualization system nodes (e.g., virtualization system node 101_{G1N1}, virtualization system node 101_{G1N2}, . . . , virtualization system node 101_{G1NN}). Each virtualization system node has its own set of CPU cores (e.g., CPU cores 103₁, CPU cores 103₂, . . . , CPU cores 103_{N}). Moreover, each virtualization system node has its own set of controller virtual machines (e.g., controller virtual machine 118₁, controller virtual machine 118₂, . . . , controller virtual machine 118_{N}), each of which in turn subsumes a shard controller thread (e.g., shard controller 114₁, shard controller 114₂, . . . , shard controller 114_{N}) and a data I/O manager (e.g., data I/O manager 116₁, data I/O manager 116₂, . . . , data I/O manager 116_{N}).

As shown, each shard controller has a thread (e.g., thread 115₁, thread 115₂, . . . , thread 115_{N}) that is associated with a CPU core. However, rather than assigning all shards of the single virtual disk 109 to a shard controller thread at the same node as the single virtual disk, CPU cores of other nodes are assigned to a next shard of the single virtual disk. This can be accomplished by communicating, over network 120, from one node to another node, instructions for the other node to implement a shard controller in one of its available CPU processors or CPU cores.

In some cases, a round-robin algorithm is used to assign successive next shards to successive next CPU cores of successive virtualization system nodes. In the specific configuration having the shown shard-controller-to-core associations 117, shard S1 is associated with a CPU core of virtualization system node 101_{G1N1}, shard S2 is associated with a CPU core of virtualization system node 101_{G1N2}, and shard SN is associated with a CPU core of virtualization system node 101_{G1NN}.

In some cases an architecture-aware round-robin algorithm is used in selecting a target node for a shard controller based at least in part on availability of two or more free cores of the target node. That is, an architecture-aware round-robin algorithm can identify hardware-specific configurations and/or availability of said hardware. As such, when selecting a target node to host a shard controller, the architecture-aware round-robin algorithm can preferentially select a target node that has greater availability and/or capability. In some cases, the architecture-aware round-robin algorithm can implement target node selection by preferentially selecting a target node based at least in part on availability of an RDMA NIC.

Of course a round-robin algorithm is not the only algorithm that can be used to form shard-controller-to-core associations. Strictly as one example, although it is graphically depicted that each shard is the same size, shards can be of any size. In fact, and as discussed in further detail below, shards can change in size dynamically and in response to observed I/O behaviors over various shards. In some cases, shards are purposely sized to correspond to the availability of processing power of a virtualization system node. For example, if shard S4 (not shown) were larger (or more busy with I/Os) than shard S3, then during the process of making shard-controller-to-core associations, the assigned shard controller thread might be set with an affinity to a CPU core of a virtualization system node that has a CPU with a higher clock rate.

As can now be understood, when an I/O is seen (e.g., an I/O from any one of the executable workload components 143), that I/O is considered to determine which shard of the single virtual disk the I/O pertains to. The I/O is routed to a corresponding shard controller. In some cases, the shard controller is assigned to a CPU core on a different node. One possible routing technique is shown and described as pertains to FIG. 1F.

FIG. 1F depicts an I/O routing technique. As an option, one or more variations of I/O routing technique 1F00 or any aspect thereof may be implemented in the context of the architecture and functionality of the embodiments described herein and/or in any environment.

The figure is being presented to illustrate how an I/O generated by the executable workload components 143 of the node that is executing the workload can be routed to another node. More specifically, the figure illustrates how an I/O generated by the executable workload components 143 on a particular virtualization system node (e.g., virtualization system node 101_{G1N1}) can be routed by that virtualization system node's data I/O manager (e.g., data I/O manager 116₁) to another node.

As shown, routing flow 181 commences upon receipt of an incoming I/O. The block address that forms a part of the I/O is correlated to a particular shard (step 182). Next, a shard-to-shard-controller map is consulted (step 184) to determine which shard controller should be designated to handle the incoming I/O. After that, a shard-controller-to-node map is consulted (step 186) so as to determine the node that will host the determined shard controller.

In the particular embodiment shown, the data I/O manager then repackages the incoming I/O into a routed I/O 129, and routes the repackaged I/O to the determined node (step 188). The shard controller at the determined node receives the routed I/O 129 and processes it, ultimately resulting in the routed I/O being applied to the single virtual disk 109 at the node that is hosting the workload. The inter-node routing of the I/O can be done with only a minimum of latency. Moreover, a high-performance map from the I/O address to node can be dynamically maintained such that there are only a few instructions (e.g., just one look-up) required to determine a target node from a virtual disk identifier and a corresponding I/O (e.g., block) address.

In some embodiments, some or all functions of the routing flow 181 are offloaded to a designated agent (e.g., hypervisor, ancillary control process, companion thread, virtualization system components, etc.). In cases, where some or all of the functions of the routing flow 181 are implemented in a hypervisor, the hypervisor can itself initiate the action to forward the I/O. Strictly as one example, upon receiving an I/O destined for a particular shard, the hypervisor can fetch any portion or combination of any one or more of a shard-to-shard-controller map, a shard-controller-to-node map, or a shard-controller-to-thread map, and thereby determine onward routing. In some cases, the I/O is forwarded to an agent (e.g., a controller virtual machine (CVM)) running on the same node as the data I/O manager. In some cases, the I/O can be forwarded to an agent running on another node.

The choice of which actions of the routing flow 181 are implemented in which agents can be made during virtualization system development and/or deployment. Furthermore, in some embodiments, a preferred location for placing an agent can be made dynamically based on then-current resource conditions.

Strictly as an example of dynamic placement, consider a scenario where the CPU of the node that is hosting the workload is very busy with compute-intensive processing. Also consider that in such a busy situation, a new I/O might need to wait several tens of milliseconds to be serviced on that busy node. Further consider that a link 160 (e.g., a low-latency link that interconnects a two or more nodes of the cluster) might be implemented using remote direct memory access network interface card (RDMA NIC) and/or other direct memory access technologies (e.g., CXL.memory), and as such, round-trip routing of an I/O might incur only a hundred microseconds or so of latency. This then provides the opportunity for extremely high performance vDisk I/O processing that is afforded by concurrency of operation of many shard controllers and/or their agents, any two or more of which are implemented as independent CPU threads (e.g., independent and concurrently executable threads assigned to separate CPU cores of two or more). Furthermore, extremely high performance vDisk I/O is afforded by virtue of assignment of functions of the routing flow 181 to nodes that have available CPU cycles.

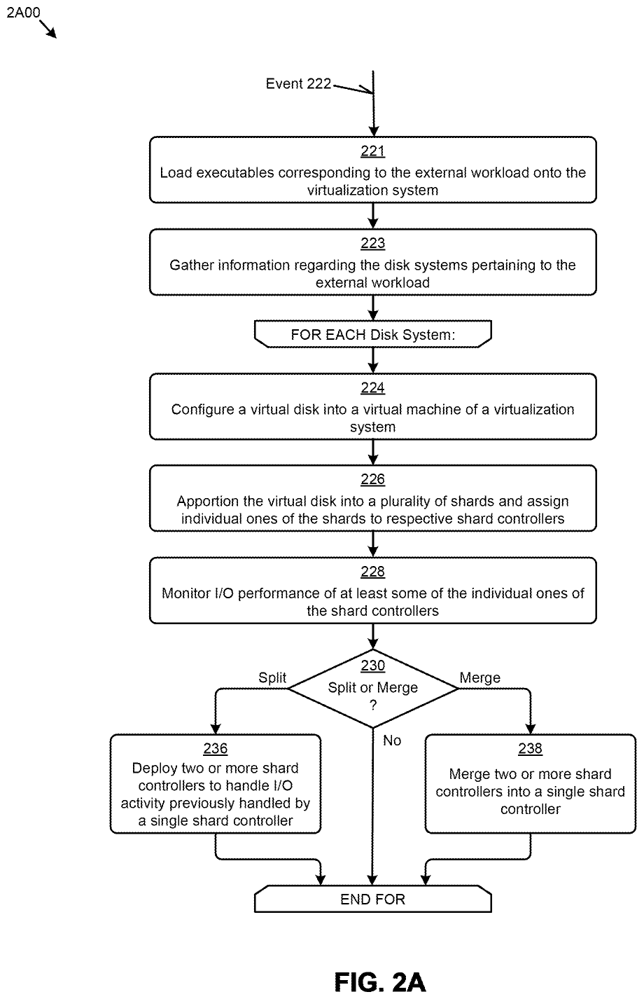

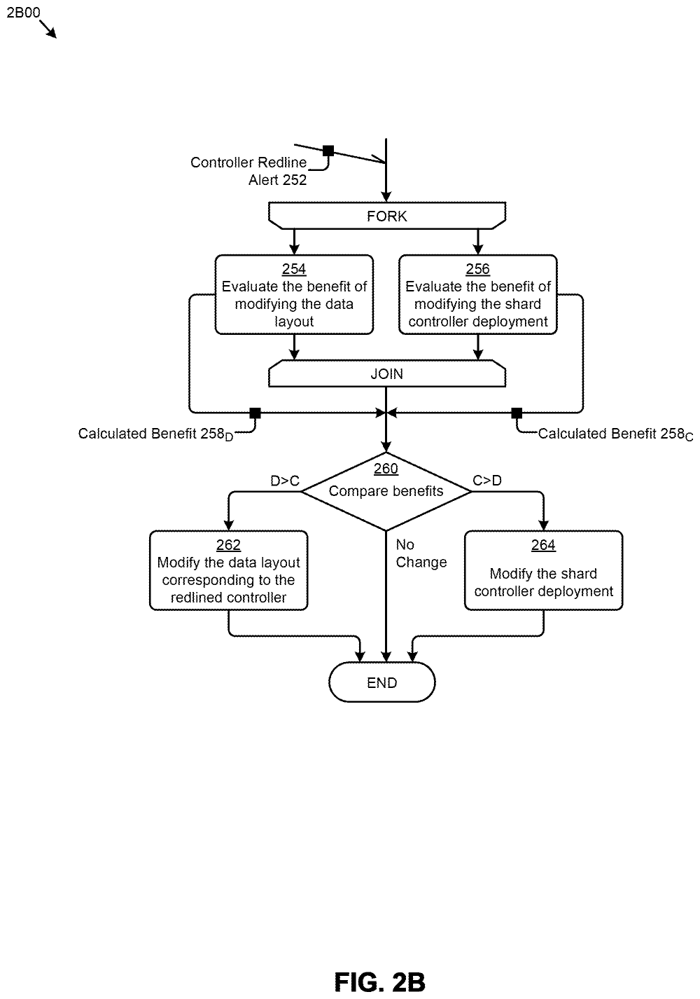

As can now be understood, a workload from an external system that relies on a large volume can be imported into a virtualization system in a manner that allows the large volume to remain appearing as a single volume (e.g., a virtual volume) to the workload, even though the I/O processing capabilities delivered to the workload are many times greater than were possible on the external system. Further, the virtual disk data layout (e.g., shard boundary designations) as well as the shard controller deployment (e.g., where each shard controller is deployed) can be managed dynamically and in response to observed I/O behaviors over various shards. One technique for dynamic creation and maintenance of sharded virtual storage areas is shown and described as pertains to FIG. 2A.

FIG. 2A is a flowchart showing a method for dynamic creation and maintenance of sharded virtual storage areas. As an option, one or more variations of method for dynamic creation and maintenance of sharded virtual storage areas 2A00 or any aspect thereof may be implemented in the context of the architecture and functionality of the embodiments described herein and/or in any environment.

The shown method commences upon event 222, which event signals that a workload of an external system is to be loaded into a virtualized computing cluster (step 221). An administrator or computing agent gathers information regarding any disk systems used by the workload at the external system (step 223). Then, for each disk system discovered, a corresponding virtual disk (step 224) is configured into the virtualization system. Also, for each disk system discovered the corresponding virtual disk is apportioned into shards, which shards are each assigned to respective shard controllers (step 226).

The shard controllers are each configured to be able to observe its own I/O behaviors over its assigned shard (step 228). As such, any given shard controller can determine for itself if it is overutilized or exceeding a utilization threshold (e.g., using 80% or more of its CPU core's cycles), or if it is underutilized or below a utilization threshold (e.g., using 40% or less of its CPU core's cycles). Dynamically, based at least in part on the aforementioned observations, a particular overutilized shard controller can autonomously split itself into two shard controllers or, alternatively, a particular shard controller can facilitate merging itself with another underutilized shard controller.

Such dynamic creation and maintenance of sharded virtual storage areas can be carried-out indefinitely. Hysteresis and filters can be used to prevent thrashing (e.g., rapid splitting and merging) of shards. Also, heuristics can be applied such that decision 230 is carried out only on some periodic basis. For example, decision 230 might be entered only once per day, or only during a period of quiescence of the workload, etc. Regardless of the technique used to enter decision 230, decision 230 can determine of a shard (and its shard controller) should be split into two shards (with respective shard controllers) or whether the shard (and its shard controller) should be merged with a different shard, together with its respective shard controller. In the former case, the “Split” branch of decision 230 is taken. In the latter case, the “Merge” branch of decision 230 is taken. Of course there can be many situations when even though decision 230 is entered, decision 230 determines that there should be neither a split nor a merge and, as such, the “No” branch of decision 230 is taken. This can happen when a shard is deemed as neither overutilized nor underutilized.

When the “Split” branch of decision 230 is taken, then two or more shard controllers are deployed to handle the I/Os that were previously handled by the subject shard controller (step 236). When the “Merge” branch of decision 230 is taken, then two or more shard controllers are merged into a single shard controller, and this single merged shard controller thenceforth handles the I/Os that were previously handled by the aforementioned two or more shard controllers (step 238).

The determination as to which two (or more) shard controllers are to be merged into a single chard controller can be done using any known technique. Strictly as examples (1) each shard controller can periodically report its observations to a node that handles collection of such observations, or (2) each shard controller or its agent can access a shard map (e.g., a shard-to-shard-controller map) to determine an adjacent shard as a candidate, or (3) the aforementioned node that handles collection of observations can be queried with a request for one or more candidate chard controller(s) that would then be merged into a single shard controller.

Some embodiments support extremely large vDisk volumes where a single virtual disk can efficaciously span across multiple nodes of the virtualization system. In such embodiments, it is possible to consider the relative benefits of (1) changing the inter-node layout of such vDisk volumes that span across multiple nodes of the cluster (e.g., by moving data from one node to another node) as compared to (2) changing the shard controller deployment (e.g., by merging or splitting a shard controller). One technique for doing so is shown and described as pertains to FIG. 2B.

FIG. 2B is a flowchart showing a method 2B00 to choose between changing a virtual disk data layout or changing a shard controller deployment. The figure is being presented to illustrate one possible technique for calculating relative benefits of changing the layout of a virtual disk versus the benefits of changing the shard controller deployment (e.g., by splitting a shard controller into multiple shard controllers, or by merging multiple shard controllers into a single shard controller).

In the embodiment of FIG. 2B, method 2B00 commences upon receipt of an alert (e.g., the shown controller redline alert 252). Responsive to receipt of such an alert, the method initiates two (or more) evaluations. One of the evaluations (e.g., evaluation 254) calculates a potential benefit of changing a virtual disk data layout (e.g., calculated benefit 258_{D}). Another one of the evaluations (e.g., evaluation 256) calculates a potential benefit of changing the shard controller deployment (e.g., calculated benefit 258_{C}). When both evaluations have completed, decision 260 is entered.

Decision 260 compares the calculated benefits. If the benefit of changing the virtual disk data layout outweighs the benefit of changing the shard controller deployment (e.g., calculated benefit 258_{D}>calculated benefit 258_{C}), then the “D>C” branch of decision 260 is taken and step 262 is entered so as to begin the process of modifying the virtual disk data layout of the shard corresponding to the redlined controller. On the other hand, if the benefit of changing the shard controller deployment (e.g., calculated benefit 258_{C}>calculated benefit 258_{D}) outweighs the benefit of changing the virtual disk data layout, then the “C>D” branch of decision 260 is taken and step 264 is entered so as to begin the process of modifying the shard controller deployment.

In some cases, the calculated benefit or benefits do not warrant changes to either to the virtual disk data layout or to the shard deployment. In such cases, the “No Change” branch of decision 260 is taken and the method ends.

In some situations, a change to a shard controller deployment includes moving the shard controller from one node to another node. This situation might arise when the node on which a particular shard is situated has been deemed to be saturated, or when the node on which the particular shard is situated has been deemed to be downed or scheduled for temporary or permanent decommissioning.

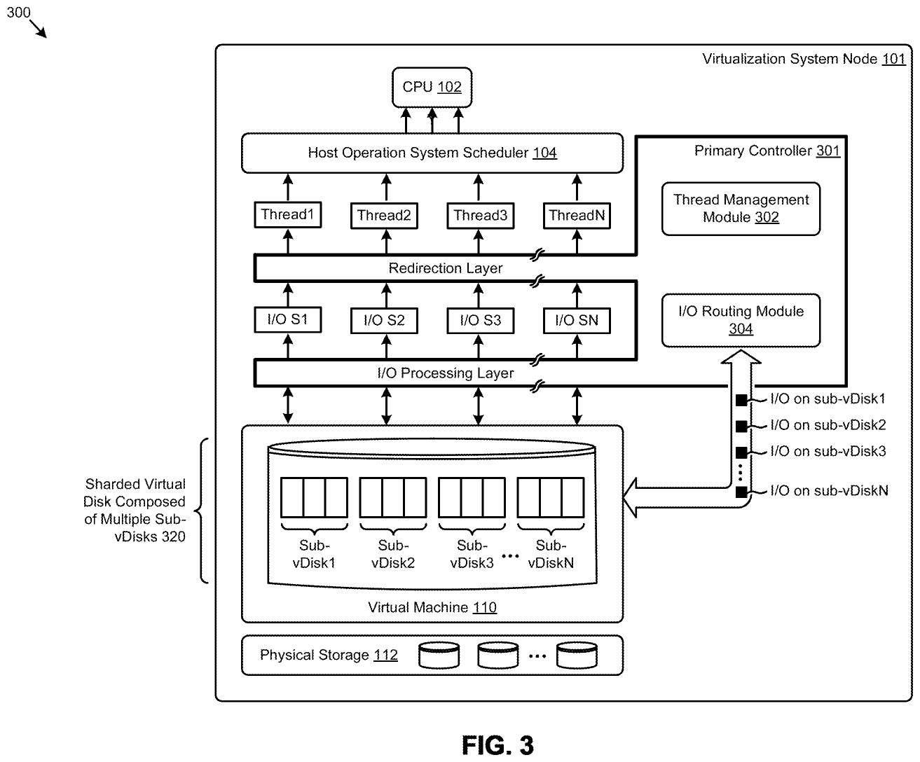

In some situations, a change to a shard controller deployment includes assigning a subject shard controller to a CPU core of a node that already has a shard controller that is assigned to a different CPU core of the same node. Techniques for handling such a case is shown and discussed as pertains to FIG. 3.

FIG. 3 is a diagram showing a primary controller deployment in a system that implements dynamic creation and maintenance of shard controllers in a virtualization system. As an option, one or more variations of the primary controller deployment 300 or any aspect thereof may be implemented in the context of the architecture and functionality of the embodiments described herein and/or in any environment.

The heretofore-disclosed routing techniques (e.g., routing flow 181 of FIG. 1F) include techniques for routing between nodes (inter-node routing). However, in certain situations, a node that already has a shard controller might be a candidate for hosting another shard controller. This can happen, for example, when temporarily or permanently decommissioning a node from a cluster. In such a situation, it can happen that a new shard controller is assigned to a CPU of a node that is already hosting a shard controller. In such a situation, intra-node routing is needed.

FIG. 3 depicts a primary controller 301 that handles I/O routing (e.g., via I/O routing module 304) as well as thread management (e.g., via thread management module 302). To explain, when an I/O (e.g., I/O on sub-vDisk1, I/O on sub-vDisk2, I/O on sub-vDisk3, or I/O on sub-vDiskN) is received at an I/O routing module of a primary controller, a determination is made as to which thread the received I/O should be routed. As heretofore discussed, a virtualization system may support a shard-to-shard-controller map as well as a shard-controller-to-node map. To implement intra-node routing in an embodiment such as depicted in FIG. 3, a shard-controller-to-thread map is defined. Such a shard-controller-to-thread map is used in combination with the aforementioned shard-to-shard-controller map to uniquely identify a thread to handle an incoming I/O. Thread management module 302 serves to establish an affinity of a particular thread (e.g., any of the threads that handle I/Os in a particular node) to a corresponding CPU core.

As used herein, a shard-to-shard-controller map is an association that codifies relationships between a particular portion of a virtual disk and some identifiable portion of executable code. In some cases a shard-to-shard-controller map is a data structure. In some cases a shard-to-shard-controller map is mathematical function that returns a unique shard-controller identification number based on a given shard identification number.

As used herein, a shard-controller-to-node map is a data structure or relationships between data structures that characterize relationships between a particular identifiable portion of executable code that processes I/Os for a particular portion of a virtual disk and a particular identifiable computing facility. In some cases, the particular identifiable computing facility may be a CPU. In some cases, the particular identifiable computing facility may be a motherboard that hosts a CPU. In some cases, the particular identifiable computing facility is a network interface (e.g., a MAC address). In some cases, the particular identifiable computing facility is a network address (e.g., an IP address).

As can now be seen, any/all of the foregoing maps can be used, singly or in combination, to be able to uniquely identify a node and thread that is to be used to process an I/O on the virtual disk. In some deployment situations a primary controller is deployed onto every node that is a constituent of a node group. As such, a primary controller participates in both inter-node as well as intra-node routing of I/Os.

In some embodiments such as is shown in FIG. 3, a sharded virtual disk is composed of multiple sub-vDisks 320. The hierarchical boundary that is afforded by a sub-vDisk supports colocation of certain portions of the vDisk. More specifically, there may be application-specific reasons why a range of blocks, possibly including a range of shards, should be considered as a single unit. When such a “single unit” semantic is enabled within a system, movement of a sub-vDisk is considered as an “all-or-none” proposition. As such, when a subject sub-disk is moved (e.g., corresponding to step 262 of FIG. 2B), all of the mappings to the shard controllers of the subject sub-vDisk are reconfigured to reflect that the data itself has moved. Note that, even in cases when a portion of data of a virtual disk is moved, it is not automatically necessary that the shard controller or shard controllers corresponding to the sub-disk need to be moved as well. Rather, it might be that only the information in the maps and/or other associations (e.g., shard-to-shard-controller map, shard-controller-to-node map, shard-controller-to-thread map, shard-controller-to-core association) is changed.

The graphical depictions of shards in the foregoing figures present similarly- or identically-sized shards. However this is not necessarily the case. Moreover, the graphical depictions of shards in the foregoing figures present similar or identical I/O activity over the shards. This is also not necessarily the case. In particular, in most cluster deployments, including any of the heretofore-described deployments, the I/O activity over the shards may vary significantly with respect to one shard or another. For example a first shard might overlap with an index of a file system while every other shard overlaps a file of the file system. As such, the shard that overlaps the index is likely to see many more I/Os that do the shards that correspond to the files. To accommodate this situation, and specifically to ensure that no shard controllers are overly busy (or overly idle), a dynamic shard controller redeployment technique can be implemented.

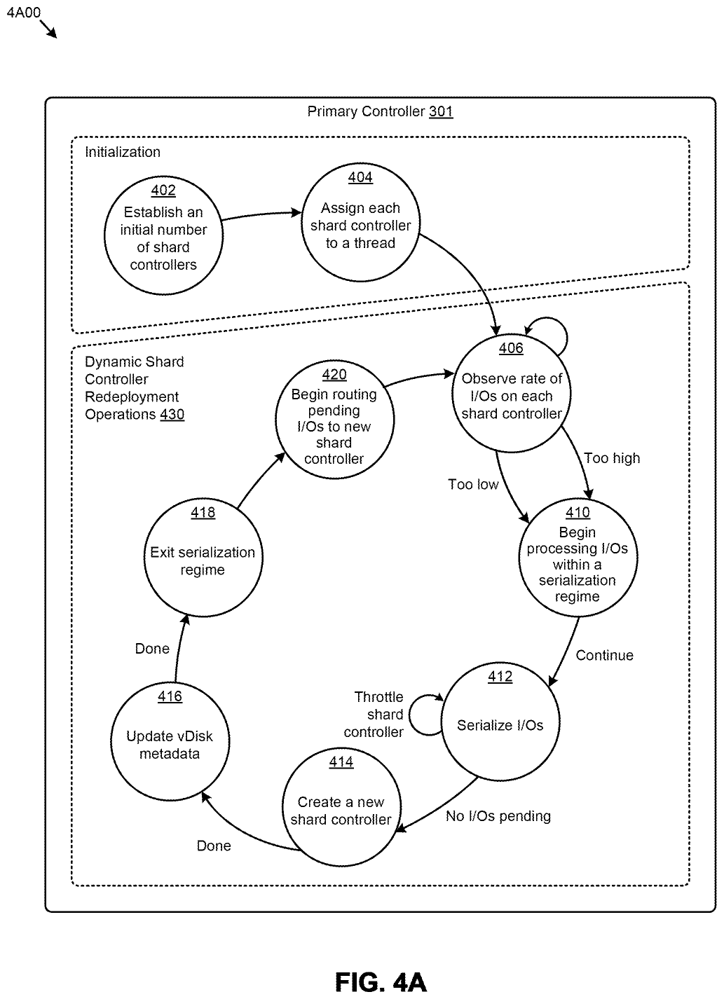

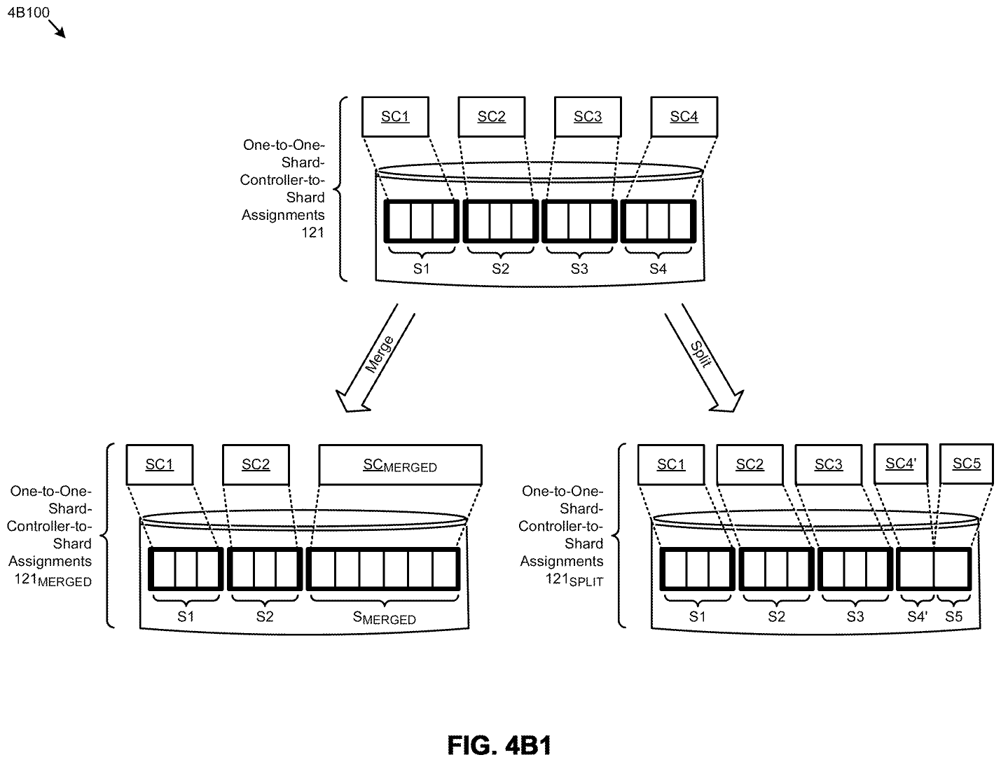

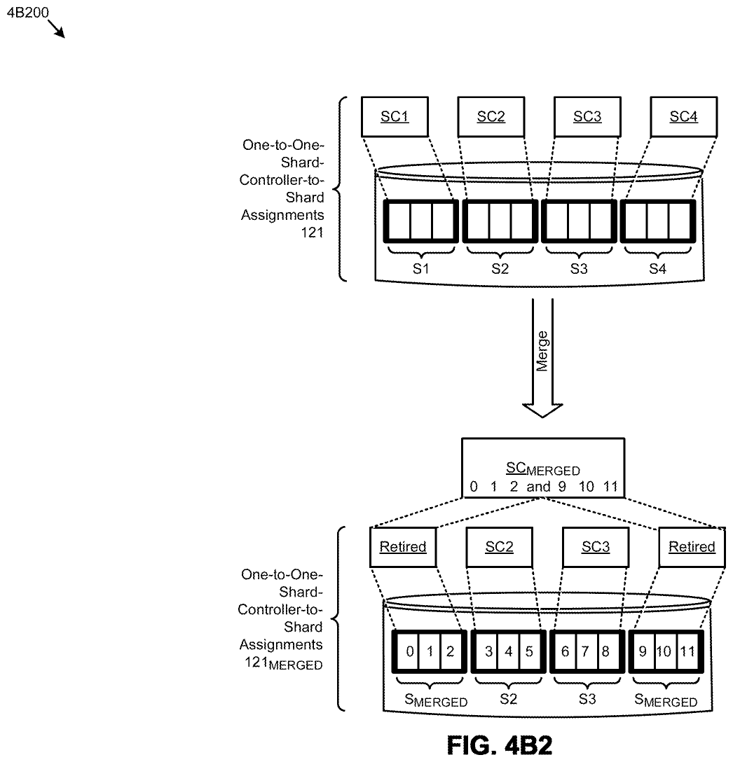

FIG. 4A is a state chart showing a dynamic shard controller redeployment technique that implements initial creation and ongoing maintenance of sharded virtual storage areas of a virtualization system. As an option, one or more variations of dynamic shard controller redeployment technique 4A00 or any aspect thereof may be implemented in the context of the architecture and functionality of the embodiments described herein and/or in any environment.

The figure is being presented to illustrate how any arbitrary deployment of shard controllers can be dynamically redeployed based on real-time observations. In the particular example of FIG. 4A, operations of the shard controller redeployment technique are carried out within a primary controller, however the operations of the shard controller redeployment technique can be implemented wholly or partially in any other module.

As shown, state 402 of the state chart serves to establish an initial number of shard controllers, and state 404 serves to assign such shard controllers to respective threads. After such initialization, then, at state 406, continuous observation of the rate of I/Os on each shard is commenced. It can happen that the rate of I/Os on a particular thread can be deemed to be “too high” or “too low”. A “too high” determination corresponds to the aforementioned “Split” case, whereas a “too low” determination corresponds to the aforementioned “Merge” case.

During the timeframe when split or merge operations are in the process of being carried out, a serialization regime is entered (state 410) and I/Os are (temporarily) processed serially (state 412). This is so that there is never a situation where a particular I/O could be handled by two different threads. To aid in administration of this serialization regime, when a subject shard controller is merged with another one or more shard controllers, a new shard controller instance is created (state 414). When the I/Os on the former shard controller threads have quiesced, then the former shard controller threads are destroyed and the I/Os that had formerly corresponded to the subject shard controller—and the other one or more shard controllers—are now routed to the newly created shard controller.

In accomplishing the foregoing split or merge operations, metadata (e.g., address ranges, mapping tables, etc.) pertaining to the vDisk are updated (state 416) to reflect the split or merge. At this point, the serialization regime can be exited (state 418), and routing to the various shard controllers (e.g., the newly-created shard controller) can begin (state 420). The observations of state 406 are again considered, and in the event that there is a “too low” or “too high” determination, the dynamic shard controller redeployment operations 430 can be performed anew.

FIG. 4B1 is a diagram 4B100 showing dynamic shard controller redeployment techniques that implement shard controller merging and splitting, according to an embodiment. The figure is being presented to illustrate that even when two or more shard controllers are merged and/or even when a single shard controller is split into multiple shard controllers, the actual data placement of the underlying virtual disk need not be changed. Rather, additional (or fewer) shard controllers can be assigned to additional (or fewer) shards of the virtual disk. The shards themselves can be resized based on the merge or split characteristics.

The left side of FIG. 4B1 depicts a merge scenario. As can be seen, responsive to a merge operation, two shard controllers have been merged into a single shard controller. In this example, the two shard controllers showing as SC3 and SC4 have been merged into a single shard controller SC_{MERGED} corresponding to shard SM_{ERGED}, which comprises the range of data on the vDisk corresponding to the former shard S3 and shard S4. After completion of the merge operation, there still remain one-to-one shard-controller-to-shard assignments (e.g., shown as one-to-one shard-controller-to-shard assignments 121_{MERGED}).

The right side of FIG. 4B1 depicts a split scenario. Responsive to a split operation, a single shard controller has been split into multiple shard controllers. In this example, the single shard controller showing as SC4 has been split into two shard controllers SC4′ and SC5. After completion of the split operation, there still remain one-to-one shard-controller-to-shard assignments (e.g., the one-to-one shard-controller-to-shard assignments 121_{SPLIT}, as shown).

As heretofore disclosed as pertains to FIG. 1D, it can happen that one or more vDisk blocks that are assigned to a particular shard may not be contiguous with respect to any other vDisk blocks that are assigned to the same particular shard. Moreover, merging can be accomplished by merging multiple non-contiguous shards into a new (merged) shard. In such cases, the number of shards of the vDisk system may change dynamically. Further, in some cases shard identifiers can be reduced to a numeric identifier and that numeric identifier can be used in a block-to-shard mathematical function such that a mapping data structure for block-to-shard correspondence becomes unneeded. An illustrative example of this is shown and described as pertains to FIG. 4B2.

FIG. 4B2 is a diagram showing a dynamic shard controller redeployment technique that implements shard controller merging of multiple non-contiguous shards. In this example case, two non-contiguous shards (e.g., shard S1 and shard S4) and their respective shard controllers (e.g., shard controller SC1 and shard controller SC4) are merged into a single shard SM_{ERGED} which is mapped to a corresponding shard controller SC_{MERGED}. As can be seen, an I/O for any of blocks 0,1, 2, or for any of blocks 9, 10, or 11 are mapped to shard controller SC_{MERGED}.

The foregoing is merely an example. Other numbers of shards and other block mappings are possible. In some mappings of blocks to shards, the shards can be composed of any number of non-contiguous blocks. Consider a case where shard S1 is defined to have blocks (0, 4, and 8), where shard S2 is defined to have blocks (1, 5, and 9); where shard S3 is defined to have blocks (2, 6, 10), and where shard S4 is defined to have blocks (3, 7, and 11). Now consider that it might happen, responsive to a merge operation, that the number of shards comprising the vDisk, as well as their numeric identification is changed. Further, it might happen that, responsive to the same merge operation, the shard-to-block assignments are also changed dynamically such that each shard number can be computed (e.g., using a modulo function) from a given block number. For example, shard S0 (i.e., shard number ‘0’) can become defined to have blocks (0, 3, and 6), shard S1 (i.e., shard number ‘1’) can become defined to have blocks (1, 4, and 7), and a merged shard S2 (i.e., shard number ‘2’) can become defined to have blocks (2, 5, 8, and 11). As such, and in accordance with this model, the block id to shard number can be computed using a modulo function. Specifically, shard_num=block_id % number_of_shards, where “%” is the modulo operator. For example, after merging a 4 shard vDisk system into a 3 shard vDisk system, block 4 would be mapped to shard S1 because 4 modulo 3 is 1 (referring to the numeric ‘1’ of shard S1), block 11 would be mapped to shard S2 because 11 modulo 3 is 2 (referring to the numeric ‘2’ of shard S2), and so on. Again, the foregoing is merely one example, and other techniques can be used to map logical vDisk blocks to corresponding shards. Moreover, any of the foregoing mapping, correlation, and/or association techniques involving one or more data structures can be implemented efficiently by using a numeric value as a portion of an identifier, and then using an arithmetic function that evaluates to a number value that corresponds to the numeric value portion of the identifier.

### Additional Features of the Disclosure

Ongoing vDisk Monitoring

In some embodiments, a monitoring process tracks the CPU usage per vDisk and provides criteria that informs decisions on whether and how to apportion a vDisk to shards and/or to respective shard controllers. For example, as the CPU usage for a particular shard starts reaching a predetermined limit (e.g., 80%), the monitor reports the observed CPU usage and initiates a split of the shard. Conversely, when CPU usage is seen to be consistently lower such that the vDisk is consuming, for example, less than 40% of the CPU, two shards can be merged. The maximum amount of CPU capability on a particular node will inform the maximum limits.

In some embodiments, every vDisk is configured with a primary controller. Such a primary controller manages the number of shard controllers for the vDisk and decides whether to and when to split a shard controller or to merge multiple shard controllers. In some embodiments, a shard controller shares the same code as the code for a primary controller, the difference between the two being that prior to, or during execution, one configuration is set to a first mode and a second configuration is set to a different mode.

### Primary Controller Deployment

In some of the examples shown in the figures and discussed herein, there is exactly one primary controller per vDisk. Each primary controller can handle any number of shard controllers. Implementation of a primary controller also has the characteristic that all external APIs remain unchanged. As such, client workloads need not be aware of the number of shard controllers and/or when or how the distribution happens. In some of the examples shown in the figures and discussed herein, the primary controller itself doesn't perform any actual I/O. Instead, the primary controller reroutes both inbound and outbound I/O requests pertaining to the respective shard and then sends the responses back to the client when the I/O is deemed complete.

When the number of shards change, it is possible that two shard controllers, or more specifically two threads that are assigned to the two shards, may find that the data they want to access exists in the same data block or extent group and thus both threads might try to conflict when making updates to that same data block or extent group. To avoid this scenario, a compare and swap (CAS) mechanism is implemented to protect the extent group's metadata in a manner that ensures that a first update has completed before a second update is attempted.

Transparent Ongoing vDisk Shard Controller Deployment

When the shard controller deployment is performed independently from the way the data is sized and/or laid out makes shard management completely transparent to any applications or other application-level software running on the cluster. As such, dynamic handling of shard configuration and reconfiguration handles the node upgrade scenarios. For example, when a cluster that is being subjected to an upgrade, that cluster can be upgraded automatically to match the node resource configuration of the upgraded cluster. Associated performance improvements are thereby achieved without any user intervention.

### Multiple Function Executors Per Controller

One way to further exploit parallelism is to assign multiple threads per controller is by using a vector of function executors (FEs) that can schedule incoming I/O operations across the function executors. The locks and state variables of any shard controller can be made common to the function executors. In some cases, certain data structures (e.g., maps) can be made exclusive to a function executor or shard controller as a whole. Some embodiments maintain a copy of states on a per function executor basis. Strictly as example, such managed stated might include a state that comports with the semantics of “Shard Write State”.

### Statistics

Various embodiments implement statistics pertaining to ongoing usage, performance and accesses that are maintained at a vDisk level (vDiskUsageStat, VDiskPerfStat, VDiskAccessMap, VDiskAccessMapReadWrite, VDiskWorkingSetSize, VDiskCacheSizeEstimator). Any module, process or thread can access statistics. In some cases a lock is required to ensure serialized access to the access statistics.

### External VDisks

A vDisk can be backed by an external storage entity. In such cases, the I/Os on the vDisk are handled so as to accommodate the external entity

Extending a Sharded vDisk

A sharded vDisk can be extended. Consider a sharded vDisk of size 64 GB with 4 vDisks shards. At some point the data written to the sharded vDisk might need to grow beyond the 64 GB. Extending the sharded vDisk can be accomplished by appending additional virtual address space that is backed by non-volatile storage.

### System Architecture Overview

### Additional System Architecture Examples

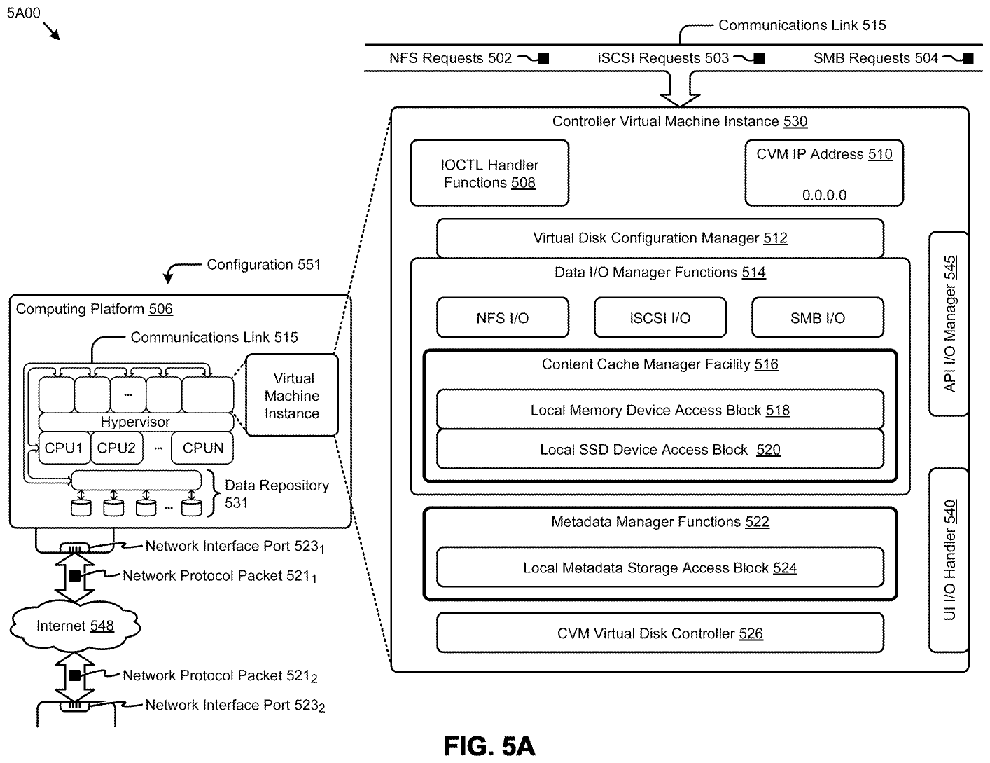

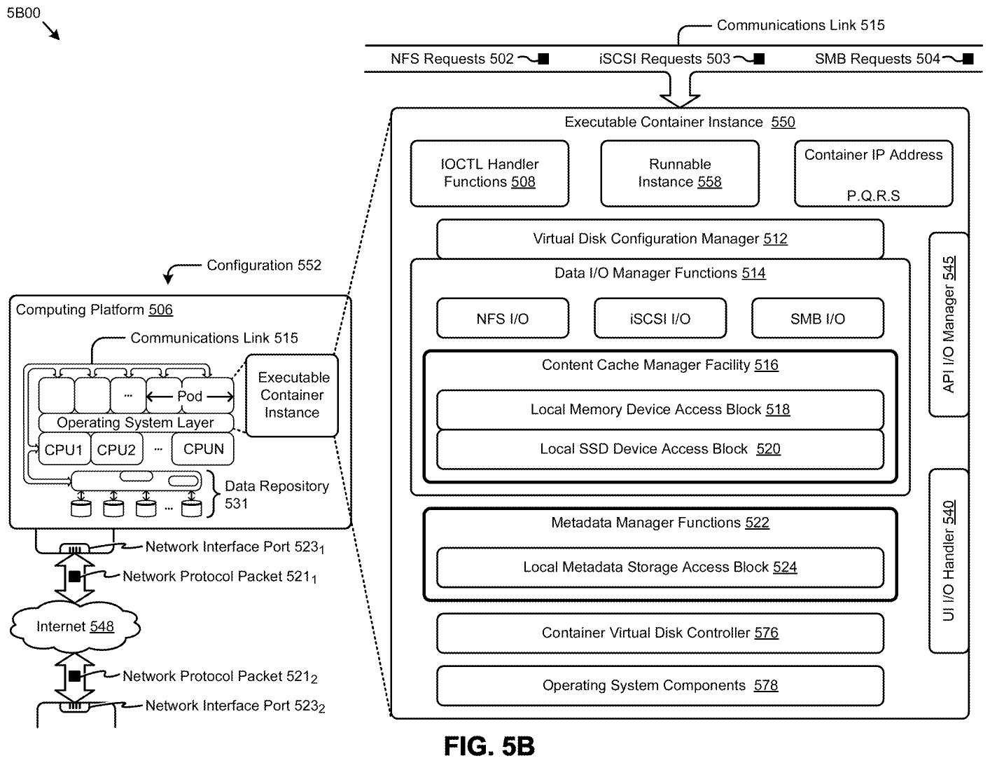

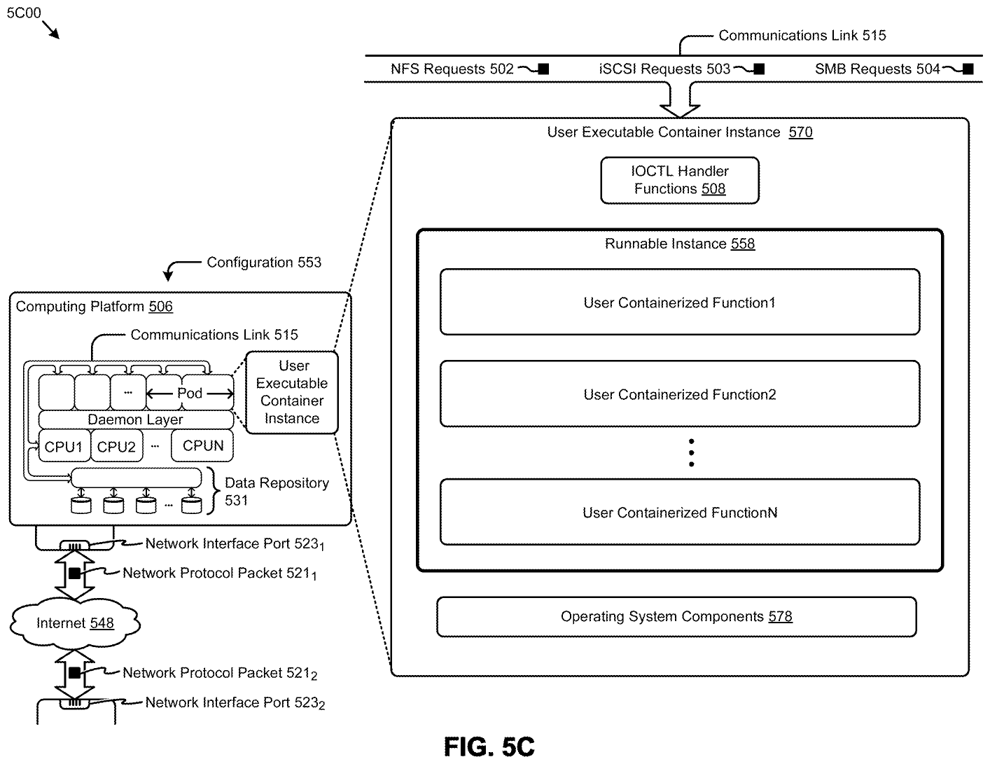

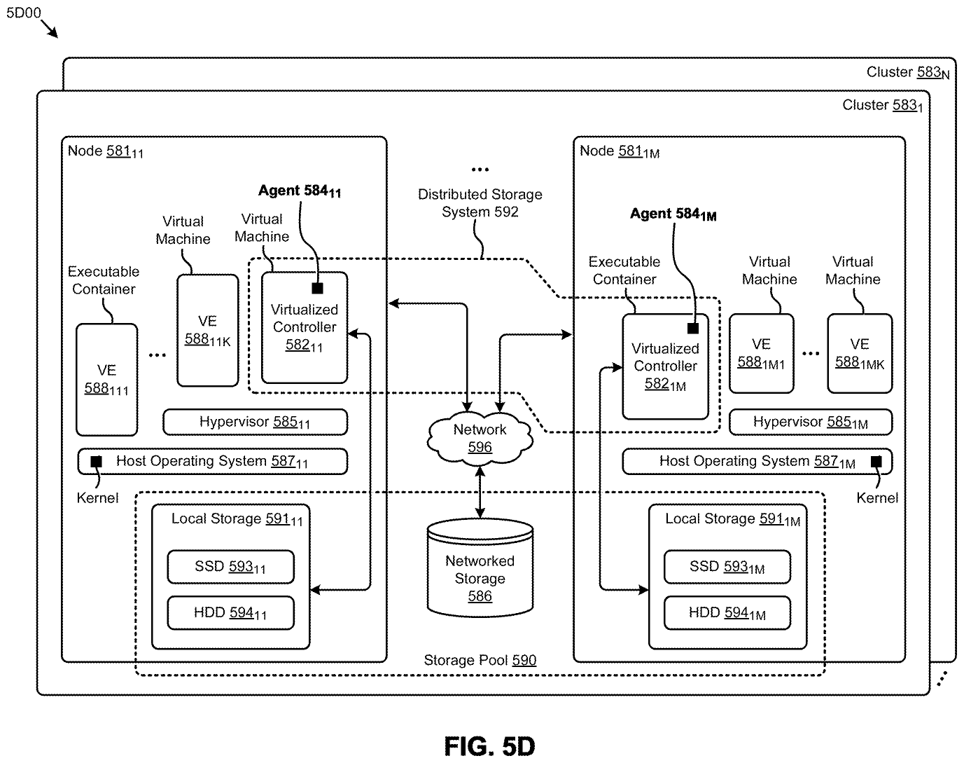

All or portions of any of the foregoing techniques can be partitioned into one or more modules and instanced within, or as, or in conjunction with, a virtualized controller in a virtual computing environment. Some example instances within various virtual computing environments are shown and discussed as pertains to FIG. 5A, FIG. 5B, FIG. 5C, and FIG. 5D.

FIG. 5A depicts a virtualized controller as implemented in the shown virtual machine architecture 5A00. The heretofore-disclosed embodiments, including variations of any virtualized controllers, can be implemented in distributed systems where a plurality of networked-connected devices communicate and coordinate actions using inter-component messaging.

As used in these embodiments, a virtualized controller is a collection of software instructions that serve to abstract details of underlying hardware or software components from one or more higher-level processing entities. A virtualized controller can be implemented as a virtual machine, as an executable container, or within a layer (e.g., such as a layer in a hypervisor). Furthermore, as used in these embodiments, distributed systems are collections of interconnected components that are designed for, or dedicated to, storage operations as well as being designed for, or dedicated to, computing and/or networking operations.

Interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

As shown, virtual machine architecture 5A00 comprises a collection of interconnected components suitable for implementing embodiments of the present disclosure and/or for use in the herein-described environments. Moreover, virtual machine architecture 5A00 includes a virtual machine instance in configuration 551 that is further described as pertaining to controller virtual machine instance 530. Configuration 551 supports virtual machine instances that are deployed as user virtual machines, or controller virtual machines or both. Such virtual machines interface with a hypervisor (as shown). Some virtual machines include processing of storage I/O (input/output or IO) as received from any or every source within the computing platform. An example implementation of such a virtual machine that processes storage I/O is depicted as 530.

In this and other configurations, a controller virtual machine instance receives block I/O storage requests as network file system (NFS) requests in the form of NFS requests 502, and/or internet small computer storage interface (iSCSI) block IO requests in the form of iSCSI requests 503, and/or Samba file system (SMB) requests in the form of SMB requests 504. The controller virtual machine (CVM) instance publishes and responds to an internet protocol (IP) address (e.g., CVM IP address 510). Various forms of input and output can be handled by one or more IO control handler functions (e.g., IOCTL handler functions 508) that interface to other functions such as data IO manager functions 514 and/or metadata manager functions 522. As shown, the data IO manager functions can include communication with virtual disk configuration manager 512 and/or can include direct or indirect communication with any of various block IO functions (e.g., NFS IO, iSCSI IO, SMB IO, etc.).

In addition to block IO functions, configuration 551 supports IO of any form (e.g., block IO, streaming IO, packet-based IO, HTTP traffic, etc.) through either or both of a user interface (UI) handler such as UI IO handler 540 and/or through any of a range of application programming interfaces (APIs), possibly through API IO manager 545.

Communications link 515 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random access persistent memories (RAPMs) or optical or magnetic media drives such as paper tape or magnetic tape drives. Volatile media includes dynamic memory such as random access memory. As shown, controller virtual machine instance 530 includes content cache manager facility 516 that accesses storage locations, possibly including local dynamic random access memory (DRAM) (e.g., through local memory device access block 518) and/or possibly including accesses to local solid state storage (e.g., through local SSD device access block 520).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of data repository 531, which in turn can be formatted into any one or more storage areas, and which can comprise parameterized storage accessible by a key (e.g., a filename, a table name, a block address, an offset address, etc.). Data repository 531 can store any forms of data, and may comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 524. The data repository 531 can be configured using CVM virtual disk controller 526, which can in turn manage any number or any configuration of virtual disks.

Execution of a sequence of instructions to practice certain embodiments of the disclosure are performed by one or more instances of a software instruction processor, or a processing element such as a data processor, or such as a central processing unit (e.g., CPU1, CPU2, . . . , CPUN). According to certain embodiments of the disclosure, two or more instances of configuration 551 can be coupled by communications link 515 (e.g., backplane, LAN, PSTN, wired or wireless network, etc.) and each instance may perform respective portions of sequences of instructions as may be required to practice embodiments of the disclosure.

The shown computing platform 506 is interconnected to the Internet 548 through one or more network interface ports (e.g., network interface port 523₁ and network interface port 523₂). Configuration 551 can be addressed through one or more network interface ports using an IP address. Any operational element within computing platform 506 can perform sending and receiving operations using any of a range of network protocols, possibly including network protocols that send and receive packets (e.g., network protocol packet 521₁ and network protocol packet 521₂).

Computing platform 506 may transmit and receive messages that can be composed of configuration data and/or any other forms of data and/or instructions organized into a data structure (e.g., communications packets). In some cases, the data structure includes program instructions (e.g., application code) communicated through the Internet 548 and/or through any one or more instances of communications link 515. Received program instructions may be processed and/or executed by a CPU as it is received and/or program instructions may be stored in any volatile or non-volatile storage for later execution. Program instructions can be transmitted via an upload (e.g., an upload from an access device over the Internet 548 to computing platform 506). Further, program instructions and/or the results of executing program instructions can be delivered to a particular user via a download (e.g., a download from computing platform 506 over the Internet 548 to an access device).

Configuration 551 is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

As used herein, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to dynamic creation and maintenance of shard controllers in a virtualization system. In some embodiments, a module may include one or more state machines and/or combinational logic used to implement or facilitate the operational and/or performance characteristics pertaining to dynamic creation and maintenance of shard controllers in a virtualization system.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of dynamic creation and maintenance of shard controllers in a virtualization system). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to dynamic creation and maintenance of shard controllers in a virtualization system, and/or for improving the way data is manipulated when performing computerized operations pertaining to assigning unique I/O handling threads to non-overlapping shards of a vDisk.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT” issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT” issued on Oct. 1, 2013, which is hereby incorporated by reference in its entirety.

FIG. 5B depicts a virtualized controller implemented by containerized architecture 5B00. The containerized architecture comprises a collection of interconnected components suitable for implementing embodiments of the present disclosure and/or for use in the herein-described environments. Moreover, the shown containerized architecture 5B00 includes an executable container instance in configuration 552 that is further described as pertaining to executable container instance 550. Configuration 552 includes an operating system layer (as shown) that performs addressing functions such as providing access to external requestors (e.g., user virtual machines or other processes) via an IP address (e.g., “P.Q.R.S”, as shown). Providing access to external requestors can include implementing all or portions of a protocol specification (e.g., “http:”) and possibly handling port-specific functions. In this and other embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node may communicate directly with storage devices on the second node.

The operating system layer can perform port forwarding to any executable container (e.g., executable container instance 550). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “ls”, “dir”, etc.). The executable container might optionally include operating system components 578, however such a separate set of operating system components need not be provided. As an alternative, an executable container can include runnable instance 558, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 576. Such a container virtual disk controller can perform any of the functions that the aforementioned CVM virtual disk controller 526 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 5C depicts a virtualized controller implemented by a daemon-assisted containerized architecture 5C00. The containerized architecture comprises a collection of interconnected components suitable for implementing embodiments of the present disclosure and/or for use in the herein-described environments. Moreover, the shown daemon-assisted containerized architecture includes a user executable container instance in configuration 553 that is further described as pertaining to user executable container instance 570. Configuration 553 includes a daemon layer (as shown) that performs certain functions of an operating system.

User executable container instance 570 comprises any number of user containerized functions (e.g., user containerized function1, user containerized function2, . . . , user containerized functionN). Such user containerized functions can execute autonomously or can be interfaced with or wrapped in a runnable object to create a runnable instance (e.g., runnable instance 558). In some cases, the shown operating system components 578 comprise portions of an operating system, which portions are interfaced with or included in the runnable instance and/or any user containerized functions. In this embodiment of a daemon-assisted containerized architecture, the computing platform 506 might or might not host operating system components other than operating system components 578. More specifically, the shown daemon might or might not host operating system components other than operating system components 578 of user executable container instance 570.

The virtual machine architecture 5A00 of FIG. 5A and/or the containerized architecture 5B00 of FIG. 5B and/or the daemon-assisted containerized architecture 5C00 of FIG. 5C can be used in any combination to implement a distributed platform that contains multiple servers and/or nodes that manage multiple tiers of storage where the tiers of storage might be formed using the shown data repository 531 and/or any forms of network accessible storage. As such, the multiple tiers of storage may include storage that is accessible over communications link 515. Such network accessible storage may include cloud storage or networked storage (e.g., a SAN or storage area network). Unlike prior approaches, the presently-discussed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In example embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

Any one or more of the aforementioned virtual disks (or “vDisks”) can be structured from any one or more of the storage devices in the storage pool. As used herein, the term “vDisk” refers to a storage abstraction that is exposed by a controller virtual machine or container to be used by another virtual machine or container. In some embodiments, the vDisk is exposed by operation of a storage protocol such as iSCSI or NFS or SMB. In some embodiments, a vDisk is mountable. In some embodiments, a vDisk is mounted as a virtual storage device.

In example embodiments, some or all of the servers or nodes run virtualization software. Such virtualization software might include a hypervisor (e.g., as shown in configuration 551 of FIG. 5A) to manage the interactions between the underlying hardware and user virtual machines or containers that run client software.

Distinct from user virtual machines or user executable containers, a special controller virtual machine (e.g., as depicted by controller virtual machine instance 530) or as a special controller executable container is used to manage certain storage and I/O activities. Such a special controller virtual machine is referred to as a “CVM”, or as a controller executable container, or as a service virtual machine (SVM), or as a service executable container, or as a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 5D depicts a distributed virtualization system in a multi-cluster environment 5D00. The shown distributed virtualization system is configured to be used to implement the herein disclosed techniques. Specifically, the distributed virtualization system of FIG. 5D comprises multiple clusters (e.g., cluster 583₁, . . . , cluster 583_{N}) comprising multiple nodes that have multiple tiers of storage in a storage pool. Representative nodes (e.g., node 5811₁, . . . , node 581_{1M}) and storage pool 590 associated with cluster 583₁ are shown. Each node can be associated with one server, multiple servers, or portions of a server. The nodes can be associated (e.g., logically and/or physically) with the clusters. As shown, the multiple tiers of storage include storage that is accessible through a network 596, such as a networked storage 586 (e.g., a storage area network or SAN, network attached storage or NAS, etc.). The multiple tiers of storage further include instances of local storage (e.g., local storage 591₁₁, . . . , local storage 591_{1M}). For example, the local storage can be within or directly attached to a server and/or appliance associated with the nodes. Such local storage can include solid state drives (SSD 593₁₁, . . . , SSD 593_{1M}), hard disk drives (HDD 594₁₁, . . . , HDD 594_{1M}), and/or other storage devices.

As shown, any of the nodes of the distributed virtualization system can implement one or more user virtualized entities (e.g., VE 588₁₁₁, . . . , VE 588_{11K}, . . . , VE 588_{1M1}, VE 588_{1MK}), such as virtual machines (VMs) and/or executable containers. The VMs can be characterized as software-based computing “machines” implemented in a container-based or hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 587₁₁, . . . , host operating system 587_{1M}), while the VMs run multiple applications on various respective guest operating systems. Such flexibility can be facilitated at least in part by a hypervisor (e.g., hypervisor 585₁₁, hypervisor 585_{1M}), which hypervisor is logically located between the various guest operating systems of the VMs and the host operating system of the physical infrastructure (e.g., node).

As an alternative, executable containers may be implemented at the nodes in an operating system-based virtualization environment or in a containerized virtualization environment. The executable containers are implemented at the nodes in an operating system virtualization environment or container virtualization environment. The executable containers comprise groups of processes and/or resources (e.g., memory, CPU, disk, etc.) that are isolated from the node host computer and other containers. Such executable containers directly interface with the kernel of the host operating system (e.g., host operating system 587₁₁, . . . , host operating system 587_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 590 by the VMs and/or the executable containers.

Multiple instances of such virtualized controllers can coordinate within a cluster to form the distributed storage system 592 which can, among other operations, manage the storage pool 590. This architecture further facilitates efficient scaling in multiple dimensions (e.g., in a dimension of computing power, in a dimension of storage space, in a dimension of network bandwidth, etc.).

A particularly-configured instance of a virtual machine at a given node can be used as a virtualized controller in a hypervisor-assisted virtualization environment to manage storage and I/O (input/output or IO) activities of any number or form of virtualized entities. For example, the virtualized entities at node 581₁₁ can interface with a controller virtual machine (e.g., virtualized controller 582₁₁) through hypervisor 585₁₁ to access data of storage pool 590. In such cases, the controller virtual machine is not formed as part of specific implementations of a given hypervisor.

Instead, the controller virtual machine can run as a virtual machine above the hypervisor at the various node host computers. When the controller virtual machines run above the hypervisors, varying virtual machine architectures and/or hypervisors can operate with the distributed storage system 592. For example, a hypervisor at one node in the distributed storage system 592 might correspond to software from a first vendor, and a hypervisor at another node in the distributed storage system 592 might correspond to a second software vendor. As another virtualized controller implementation example, executable containers can be used to implement a virtualized controller (e.g., virtualized controller 582_{1M}) in an operating system virtualization environment at a given node. In this case, for example, the virtualized entities at node 581_{1M} can access the storage pool 590 by interfacing with a controller container (e.g., virtualized controller 582_{1M}) through hypervisor 585_{1M} and/or the kernel of host operating system 587_{1M}.

In certain embodiments, one or more instances of an agent can be implemented in the distributed storage system 592 to facilitate the herein disclosed techniques. Specifically, agent 584₁₁ can be implemented in the virtualized controller 582₁₁, and agent 584_{1M} can be implemented in the virtualized controller 582_{1M}. Still more specifically, agent 584₁₁, . . . agent 584_{1M} can implement all or part of a shard controller and/or a primary controller and/or any function of a virtualized controller.

Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents.

Solutions attendant to assigning unique I/O handling threads to non-overlapping shards of a vDisk can be brought to bear through implementation of any one or more of the foregoing techniques. Moreover, any aspect or aspects of optimizing I/O performance to and from virtual storage areas of a virtualization system can be implemented in the context of the foregoing environments.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

1. A non-transitory computer readable medium having stored thereon a sequence of instructions which, when stored in memory and executed by a processor cause the processor to perform acts comprising:
importing a workload from an external system into a virtualization system;
creating a vDisk based at least in part on data of the workload;
maintaining the vDisk as a plurality of shards; and
using a plurality of shard controllers to manage respective shards of the plurality of shards.

2. The non-transitory computer readable medium of claim 1, further comprising instructions which, when stored in memory and executed by the processor cause the processor to perform further acts of:
monitoring I/O activity on at least some individual ones of the plurality of shard controllers; and
merging two or more of the shard controllers into a single shard controller when the I/O activity on the at least some individual ones of the plurality of shard controllers is measured to be below a threshold.

3. The non-transitory computer readable medium of claim 1, further comprising instructions which, when stored in memory and executed by the processor cause the processor to perform further acts of:
monitoring I/O activity on at least one of the plurality of shard controllers; and
splitting the at least one of the plurality of shard controllers into two or more shard controllers when the I/O activity on the at least one of the plurality of shard controllers is measured to be above a threshold.

4. The non-transitory computer readable medium of claim 3, further comprising instructions which, when stored in memory and executed by the processor cause the processor to perform further acts of:
selecting a target node for at least one of the two or more shard controllers, wherein the target node selection is based at least in part on availability of one or more free cores of the target node.

5. The non-transitory computer readable medium of claim 3, further comprising instructions which, when stored in memory and executed by the processor cause the processor to perform further acts of:
selecting a target node for at least one of the two or more shard controllers by identifying at least one RDMA NIC at the target node.

6. The non-transitory computer readable medium of claim 1, further comprising instructions which, when stored in memory and executed by the processor cause the processor to perform further acts of:
maintaining a data structure comprising at least one of, a shard-to-shard-controller map, a shard-controller-to-node map, or a shard-controller-to-core association.

7. The non-transitory computer readable medium of claim 1, further comprising instructions which, when stored in memory and executed by the processor cause the processor to perform further acts of:
evaluating a first calculated benefit based on modifying a shard deployment;
evaluating a second calculated benefit based on modifying a virtual disk data layout; and
modifying either the shard deployment or the virtual disk data layout based on the first calculated benefit or the second calculated benefit.

8. The non-transitory computer readable medium of claim 1, wherein the shard controllers are implemented as independent CPU threads assigned to two or more nodes of the virtualization system.

9. A method comprising:
importing a workload from an external system into a virtualization system;
creating a vDisk based at least in part on data of the workload;
maintaining the vDisk as a plurality of shards; and
using a plurality of shard controllers to manage respective shards of the plurality of shards.

10. The method of claim 9, further comprising:
monitoring I/O activity on at least some individual ones of the plurality of shard controllers; and
merging two or more of the shard controllers into a single shard controller when the I/O activity on the at least some individual ones of the plurality of shard controllers is measured to be below a threshold.

11. The method of claim 9, further comprising:
monitoring I/O activity on at least one of the plurality of shard controllers; and
splitting the at least one of the plurality of shard controllers into two or more shard controllers when the I/O activity on the at least one of the plurality of shard controllers is measured to be above a threshold.

12. The method of claim 11, further comprising:
selecting a target node for at least one of the two or more shard controllers, wherein the target node selection is based at least in part on availability of one or more free cores of the target node.

13. The method of claim 11, further comprising:
selecting a target node for at least one of the two or more shard controllers by identifying at least one RDMA NIC at the target node.

14. The method of claim 9, further comprising:
maintaining a data structure comprising at least one of, a shard-to-shard-controller map, a shard-controller-to-node map, or a shard-controller-to-core association.

15. The method of claim 9, further comprising:
evaluating a first calculated benefit based on modifying a shard deployment;
evaluating a second calculated benefit based on modifying a virtual disk data layout; and
modifying either the shard deployment or the virtual disk data layout based on the first calculated benefit or the second calculated benefit.

16. The method of claim 9, wherein the shard controllers are implemented as independent CPU threads assigned to two or more nodes of the virtualization system.

17. A system comprising:
a storage medium having stored thereon a sequence of instructions; and
a processor that executes the sequence of instructions to cause the processor to perform acts comprising,
importing a workload from an external system into a virtualization system;
creating a vDisk based at least in part on data of the workload;
maintaining the vDisk as a plurality of shards; and
using a plurality of shard controllers to manage respective shards of the plurality of shards.

18. The system of claim 17, further comprising instructions which, when stored in memory and executed by the processor cause the processor to perform further acts of:
monitoring I/O activity on at least some individual ones of the plurality of shard controllers; and
merging two or more of the shard controllers into a single shard controller when the I/O activity on the at least some individual ones of the plurality of shard controllers is measured to be below a threshold.

19. The system of claim 17, further comprising instructions which, when stored in memory and executed by the processor cause the processor to perform further acts of:
monitoring I/O activity on at least one of the plurality of shard controllers; and
splitting the at least one of the plurality of shard controllers into two or more shard controllers when the I/O activity on the at least one of the plurality of shard controllers is measured to be above a threshold.

20. The system of claim 19, further comprising instructions which, when stored in memory and executed by the processor cause the processor to perform further acts of:
selecting a target node for at least one of the two or more shard controllers, wherein the target node selection is based at least in part on availability of one or more free cores of the target node.

21. The system of claim 19, further comprising instructions which, when stored in memory and executed by the processor cause the processor to perform further acts of:
selecting a target node for at least one of the two or more shard controllers by identifying at least one RDMA NIC at the target node.

22. The system of claim 17, further comprising instructions which, when stored in memory and executed by the processor cause the processor to perform further acts of:
maintaining a data structure comprising at least one of, a shard-to-shard-controller map, a shard-controller-to-node map, or a shard-controller-to-core association.

23. The system of claim 17, further comprising instructions which, when stored in memory and executed by the processor cause the processor to perform further acts of:
evaluating a first calculated benefit based on modifying a shard deployment;
evaluating a second calculated benefit based on modifying a virtual disk data layout; and
modifying either the shard deployment or the virtual disk data layout based on the first calculated benefit or the second calculated benefit.

24. The system of claim 17, wherein the shard controllers are implemented as independent CPU threads assigned to two or more nodes of the virtualization system.
